(19) United States
(12) Patent Application Publication
(10) Pub. No.: US 2015/0286009 A1
(43) Pub. Date: Oct. 8, 2015

(54) OPTICAL DEVICE

(71) Applicant: Sumitomo Electric Industries, Ltd., Osaka-shi (JP)

(72) Inventor: Takafumi Ohtsuka, Yokohama-shi (JP)

(21) Appl. No.: 14/436,466

(22) PCT Filed: Oct. 16, 2012
(86) PCT No.: PCT/JP2012/076719

§ 371 Date: Apr. 16, 2015

(51) Int. Cl. G02B 6/35

(52) U.S. Cl. CPC G02B 6/3512; G02B 6/3518; G02B 6/3538

(57) ABSTRACT

An optical device comprises an input/output port including an input port and an output port arranged in a first direction, a dispersive element dispersing an optical signal input from the input port in accordance with the wavelength in a second direction perpendicular to the first direction so as to generate a plurality of wavelength components, a light deflection element including pixels arranged in the first direction configured to present a phase modulation pattern for independently phase-modulating each of the wavelength components, and the phase modulation pattern including a first pattern for deflecting each of the wavelength components toward the output port, and a second pattern different from the first pattern, and an anamorphic converter configuring a beam spot of the wavelength components incident on the light deflection element to an elliptical shape relatively larger in the first direction than in the second direction.

### TECHNICAL FIELD

The present invention relates to an optical device such as a wavelength selection switch.

### BACKGROUND ART

A wavelength selection device is described in Patent Literature 1. The wavelength selection device includes an input/output fiber, a spherical mirror, a cylindrical lens, a diffraction grating, and an LCD (Liquid Crystal Device). The input/output fiber is arranged in the x direction. Light from the input/output fiber enters the diffraction grating after being reflected by the spherical mirror and collimated. The light having entered the diffraction grating is angle-dispersed in the y direction in accordance with the wavelength and is emitted. The light having been emitted from the diffraction grating is condensed in the x direction and also collimated in the y direction by passing through the cylindrical lens and is reflected by the spherical mirror again. The light having been reflected by the spherical mirror again is collimated in the x direction and also condensed in the y direction by passing through the cylindrical lens again and then enters the LCD.

### CITATION LIST

### Patent Literature

[Patent Literature 1] U.S. Pat. No. 7,092,599

### SUMMARY OF INVENTION

LCOS (Liquid Crystal On Silicon) as an example of a reflection-type liquid crystal may be used as a light deflection element of the wavelength selection switch. LCOS includes a plurality of pixels. Thus, many pixels should be controlled simultaneously to deflect light efficiently and precisely. Therefore, a larger spot size of an optical beam in the port selection axis direction (for example, the arrangement direction of the input/output port) incident on the LCOS is preferable.

In the wavelength selection switch, by contrast, a high wavelength resolution is needed and as long as the number of pixels of LCOS is finite, it is necessary to make the spot size of an optical beam in the wavelength selection direction (for example, the spectral direction of the diffraction grating) smaller to some extent. That is, compared with the spot size in the wavelength selection axis direction, it is desirable to make the spot size in the port selection axis direction larger (that is, to increase the aspect ratio) on the light deflection element such as LCOS.

In the wavelength selection operation device described in the aforementioned Patent Literature 1, the spot size in each direction is changed by repeating condensing and collimation in the x direction and y direction subsequent to the diffraction grating to relatively increase the aspect ratio of spot sizes on LCD. In the wavelength selection device described in Patent Literature 1, however, even if a plurality of optical systems described above is used, the control of optical characteristics thereof is not mentioned.

An aspect of the present invention relates to an optical device. The optical device An optical device comprising: an input/output port including an input port and an output port arranged in a first direction; a dispersive element dispersing an optical signal input from the input port in accordance with the wavelength in a second direction perpendicular to the first direction so as to generate a plurality of wavelength components; a light deflection element including pixels arranged in the first direction configured to presenting a phase modulation pattern for independently phase-modulating each of the wavelength components, and the phase modulation pattern including a first pattern for deflecting each of the wavelength components toward the output port, and a second pattern different from the first pattern; and an anamorphic converter configuring a beam spot of the wavelength components incident on the light deflection element to a elliptical shape relatively larger in the first direction than in the second direction.

### BRIEF DESCRIPTION OF DRAWINGS

FIG. 1 is a schematic diagram showing the configuration of an embodiment of an optical path control device according to an aspect of the present invention.

FIG. 2 is a graph showing a phase modulation pattern in a light deflection element shown in FIG. 1.

FIG. 3 is a graph showing a phase modulation pattern in the light deflection element shown in FIG. 1.

FIG. 4 is a graph showing a phase modulation pattern in the light deflection element shown in FIG. 1.

FIG. 5 is a diagram showing a comparative example of attenuation control.

FIG. 6 is a diagram showing a state of the attenuation control of a control unit shown in FIG. 1.

FIG. 7 is a diagram showing a modification of a microlens shown in FIG. 6.

FIG. 8 is a diagram showing a modification of the optical path control device shown in FIG. 1.

### DESCRIPTION OF EMBODIMENT

Hereinafter, an embodiment of an optical device according to an aspect of the present invention will be described in detail with reference to the drawings. In the description of the drawings, the same reference signs are attached to the same components or equivalent components to omit a duplicate description.

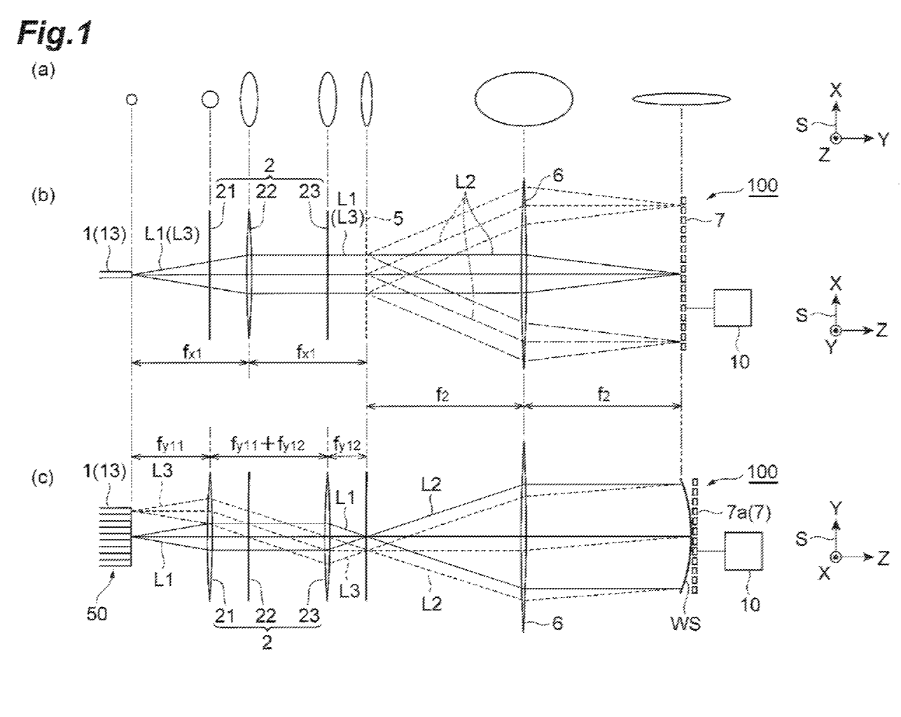

FIG. 1 is a schematic diagram showing the configuration of an embodiment of an optical device according to an aspect of the present invention. An orthogonal coordinate system S is shown. FIG. 1(a) is a diagram showing beam spots of light propagating through the optical device when viewed from the z-axis direction of the orthogonal coordinate system S. FIG. 1(b) is a side view of the optical device when viewed from the y-axis direction of the orthogonal coordinate system S. FIG. 1(c) is a side view of the optical device when viewed from the x-axis direction of the orthogonal coordinate system S.

An optical path control device 100 includes an input port 1, an anamorphic converter 2, a dispersive element 5, an optical power element 6, a light deflection element 7, a control unit 10, and an output port 13. An optical signal input from the input port 1 is deflected by the light deflection element 7 after passing through the anamorphic converter 2, the dispersive element 5, and the optical power element 6 in this order, and after passing through the optical power element 6, the dispersive element 5, and the anamorphic converter 2 in this order, output from the output port 13.

The optical power element may be, for example, a transmission-type element such as a spherical lens and a cylindrical lens, or a reflection-type element such as a spherical mirror and a concave mirror, or an element having optical power in at least one direction. The optical power is the capability to converge/collimate light by passing through or reflected by the optical power element. The optical power becomes larger as the condensing position of the optical power element becomes closer. In FIG. 1(b), 1(c), the optical power element is shown like a convex lens in a plane having optical power and like a straight line in a plane having no optical power.

The input port 1 and the output port 13 are arranged along the y-axis direction (first direction) to constitute an input/output port array (input/output port) 50. The number of each of the input port 1 and the output port 13 may be one or two or more. In the optical path control device 100, wavelength multiplexed light (optical signal) L1 is input from the input port 1.

The anamorphic converter 2 is arranged prior to the dispersive element 5. The wavelength multiplexed light L1 input from the input port 1 is incident on the anamorphic converter 2, and the anamorphic converter 2 converts the aspect ratio of the beam spot such that the spot size in the x-axis direction (second direction) of the wavelength multiplexed light L1 becomes larger than the spot size in the y-axis direction. As a result, the anamorphic converter 2 configures the beam spot of the wavelength component L2 incident on the light deflection element 7 so as to be an elliptical shape relatively larger in the y-axis direction than in the x-axis direction in a x-y plane extending in the y-axis direction and the x-axis direction.

The anamorphic converter 2 includes three cylindrical lenses 21 to 23. The cylindrical lenses 21 to 23 are arranged on the optical path from the input port 1 to the dispersive element 5 in this order. The cylindrical lenses 21, 23 have optical power only in the y-axis direction (in a y-z plane; extending in the propagation direction of the wavelength multiplexed light L1 and the y axis direction). The cylindrical lens 22 has optical power only in the x-axis direction (in an x-z plane; extending in the propagation direction of the wavelength multiplexed light L1 and the x axis direction).

The wavelength multiplexed light L1 input from the input port and propagating while expanding and then incident on the cylindrical lens 21, and the cylindrical lens 21 collimates the wavelength multiplexed light L1 in the y-z plane. The wavelength multiplexed light L1 emitted from the cylindrical lens 21 and propagating while expanding in the x-axis direction and then incident on the cylindrical lens 22, and the cylindrical lens 22 collimates the wavelength multiplexed light L1 in the x-z plane.

The wavelength multiplexed light L1 emitted from the cylindrical lens 22 incident on the cylindrical lens 23, and the cylindrical lens 23 temporarily condenses the wavelength multiplexed light L1 in the y-z plane. The wavelength multiplexed light L1 forms beam waist at the condensing position while expanding only in the y-axis direction. Thus, the beam spot is converted by the anamorphic converter 2 into an elliptical shape in which the spot size in the y-axis direction is relatively larger than the spot size in the x-axis direction subsequent to the dispersive element 5 (for example, on the optical power element 6 or the light deflection element 7).

The dispersive element 5 is arranged at the condensing position of the cylindrical lens 23 in the y-z plane. The dispersive element 5 dispersing an optical signal L1 input from the input port in accordance with the wavelength along the x-axis direction so as to generate a plurality of wavelength components (optical signals) L2 by rotating the propagation direction of the wavelength multiplexed light L1 around an axis along the y-axis direction in accordance with each wavelength. The dispersive element 5 may be a diffraction grating.

The optical power element 6 is arranged subsequent to the dispersive element 5. The optical power element 6 has optical power in the x-axis direction (in the x-z plane) and the y-axis direction (in the y-z plane).

The optical power element 6 converges each of the wavelength components L2 and makes the propagation directions parallel in the x-z plane. On the other hand, the optical power element 6 collimates each of the wavelength components L2 in the y-z plane. Accordingly, the beam spot of each of the wavelength components L2 incident on the light deflection element 7 presents an elliptical shape relatively larger in the y-axis direction than in the x-axis direction, thereby the aspect ratio of the beam spot is increased.

The light deflection element 7 is arranged at the beam waist position of the wavelength components L2 in the x-z plane. The plurality of wavelength components L2 emitted from the optical power element 6 and arranged in parallel along the x-axis direction enters the light deflection element 7.

The light deflection element 7 including pixels arranged in the y-axis direction configured to presenting a phase modulation pattern for independently phase-modulates each of the wavelength components L2. Accordingly, the light deflection element 7 rotates propagation direction of each wavelength component L2 around an axis along the x-axis direction (in the y-z plane). The light deflection element 7 deflects the wavelength components L2 in a direction substantially opposite to the incident direction of the wavelength component L2.

The pixels 7a are two-dimensionally arranged along the x-axis direction and the y-axis direction, and pixels arranged in the y-axis direction presents the phase modulation pattern contributing the deflection of the wavelength components L2. LCOS or an MEMS (Micro Electro Mechanical Systems) element including a plurality of electrically controllable and two-dimensionally arranged pixels may be used, and the phase modulation pattern may be controlled in accordance with the voltage applied to each of the pixels.

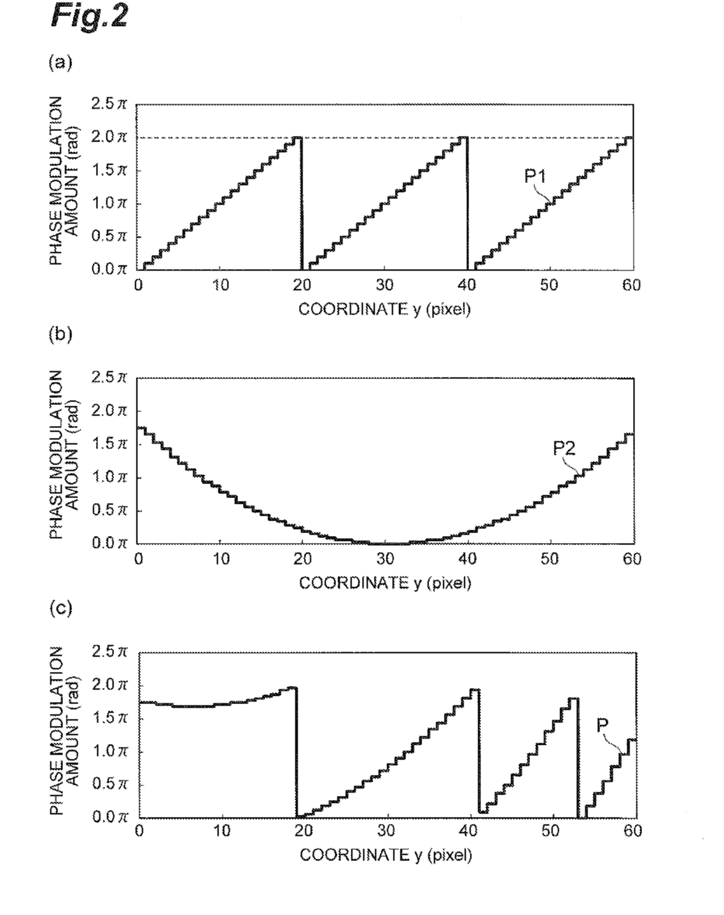

The phase modulation pattern P along the y-axis direction is described in FIG. 2(c). The phase modulation pattern P including a first pattern P1 as shown in FIG. 2(a), and a second pattern P2 as shown in FIG. 2(b) is different from on the first pattern P1. The first pattern may be a pattern to control the optical path of the wavelength components L2 and thereby wavelength components L2 is coupled to the desired output port 13. The second pattern may be different from the first pattern P1, and control aberration in the y-axis direction of each of the wavelength components L2.

The beam waist position in the x-axis direction and the y-axis direction of the wavelength components L2 incident on the light deflection element 7 are shifted from each other due to astigmatism. In the present embodiment, the light deflection element 7 is arranged at the beam waist position in the x-axis direction of the wavelength components L2 and thus, an optical wavefront WS in the y-axis direction of the wavelength components L2 incident on the light deflection element 7 has a certain curvature (see FIG. 1).

Since the phase modulation pattern P including the second pattern P2 having a curvature radius in accordance with the optical wavefront WS, the optical coupling efficiency of the wavelength components L2 to the output port 13 can be maximized by controlling the aberration. In this case, the phase modulation pattern P adjusting a wavefront of the wavelength component L2 emitted from the light deflection element 7 so as to be substantially identical to a wavefront of the wavelength component L2 entering the light deflection element 7. As shown in FIG. 2(a), the second pattern P2 corresponds to spatial phase modulation of a concave mirror having a relatively large curvature radius, and being presented on the light deflection element 7.

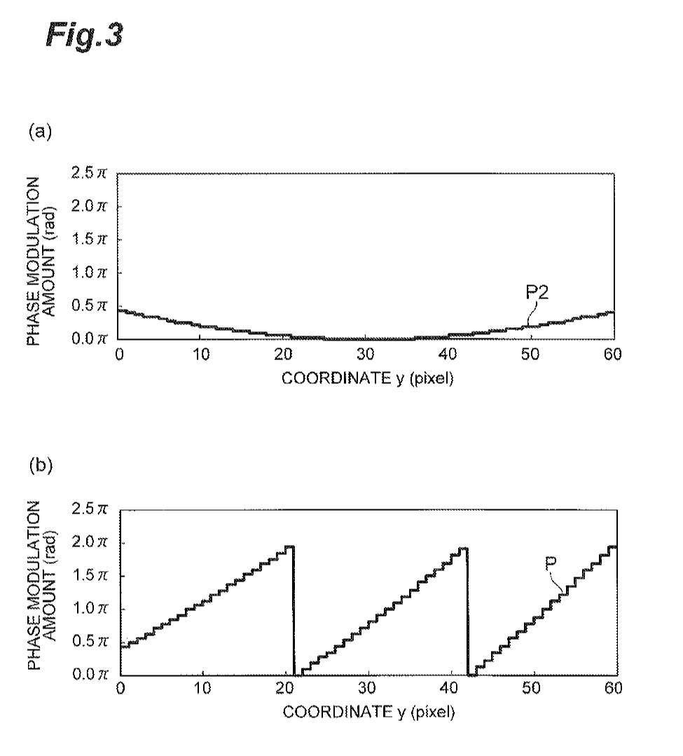

For the purpose of decreasing the optical coupling efficiency of wavelength component L2 to the output port 13, the phase modulation pattern P as shown in FIG. 3(b) may include the second pattern P2 as shown in FIG. 3(a) having the curvature radius of being intentionally shifted from the optical wavefront WS. The second pattern P2 shown in FIG. 3(a) corresponds to spatial phase modulation of a concave mirror having a relatively small curvature radius, and being presented on the light deflection element 7.

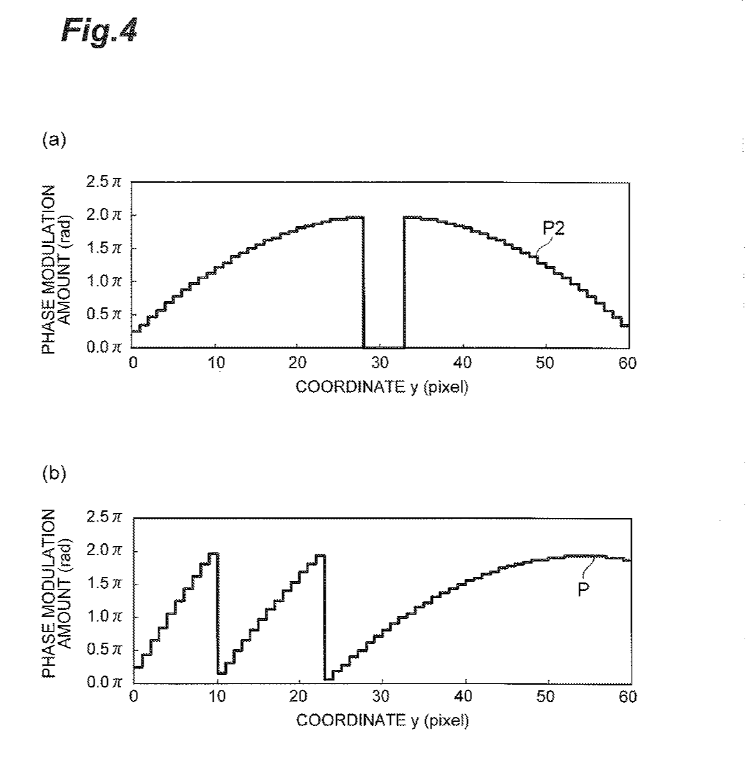

A phase modulation pattern P as shown in FIG. 4(b) including the first pattern P1 and the second pattern P2 as shown in FIG. 4(a) corresponds to a spatial phase modulation of a convex mirror having a relatively large curvature radius may be presented on the light deflection element 7.

The control unit 10 controls the light deflection element 7 for changing the phase modulation pattern P for the purpose of controlling the optical coupling efficiency. The attenuation control by the control unit 10 will be described in detail later.

As shown in FIG. 1, a wavelength component deflected by the light deflection element 7 passes through the optical power element 6, the dispersive element 5, and the anamorphic converter 2 in this order, and then output from the output port 13. The optical power element 6 rotates each of the wavelength components L2 emitted from the light deflection element 7 around an axis along the y-axis direction (in the x-z plane) in accordance with the wavelength. Each of the wavelength components L2 is condensed onto the dispersive element 5 of a predetermined position in the x-axis direction.

On the other hand, the optical power element 6 converges each of the wavelength components L2 emitted from the light deflection element 7 in the y-z plane. Each of the wavelength components L2 is condensed onto the dispersive element 5 in the y-axis direction.

The dispersive element 5 generates multiplexed light (optical signal) L3 by multiplexing one or more of the wavelength components L2 in the in the x-z plane for outputting thereof from the output port 13.

The multiplexed light L3 is incident on the anamorphic converter 2, and the anamorphic converter 2 converts the aspect ratio of the beam spot such that the spot size in the y-axis direction and in the x-axis direction are substantially equal between the dispersive element 5 and the output port 13.

The anamorphic converter 2 includes, as described above, the cylindrical lenses 23, 22, 21 arranged on the optical path from the dispersive element 5 to the output port 13 in this order. The cylindrical lens 23 collimates the multiplexed light L3 in the y-z plane.

The cylindrical lens 22 converges the multiplexed light L3 in the x-z plane. The cylindrical lens 21 converges the multiplexed light L3 in the y-z plane.

Accordingly, prior to the output port 13, the multiplexed light L3 has substantially equal sized spot in the y-axis direction and in the x-axis direction as described above, and is coupled to the output port 13.

The positional relationship of each element of the optical path control device 100 will briefly be described. In the x-z plane, the distance from the input port 1 (output port 13) to the cylindrical lens 22 and the distance from the cylindrical lens 22 to the dispersive element 5 are set to be fₓ₁. Also, the distance from the dispersive element 5 to the optical power element 6 and the distance from the optical power element 6 to the light deflection element 7 are set to be f₂. In the y-z plane, when the distance from the input port 1 (output port 13) to the cylindrical lens 21 is set to be f_{y11}, and the distance from the cylindrical lens 23 to the dispersive element 5 is set to be f_{y12}, the distance between the cylindrical lens 21 and the cylindrical lens 23 is set to be (f_{y11}+f_{y12}).

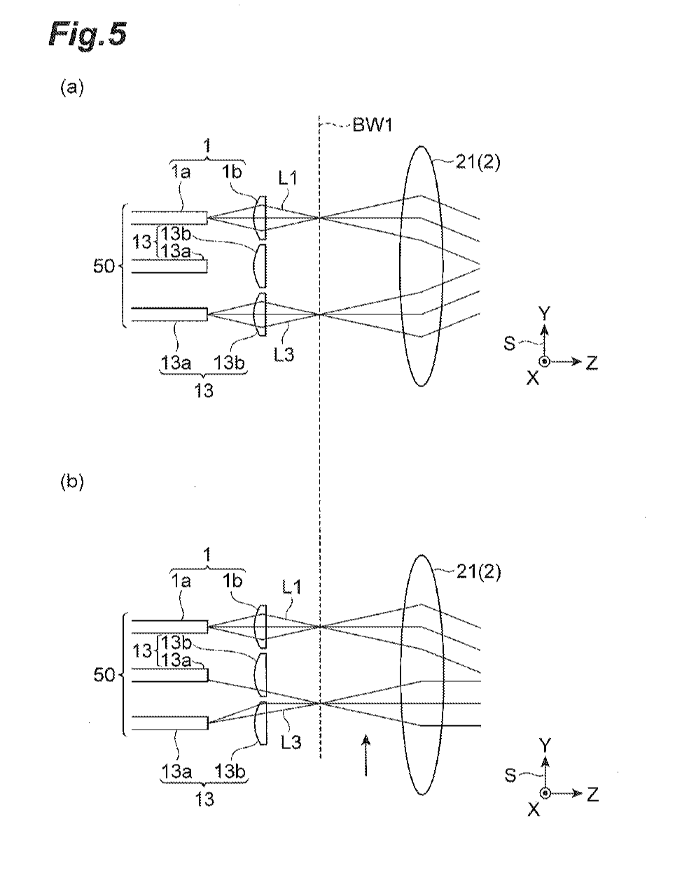

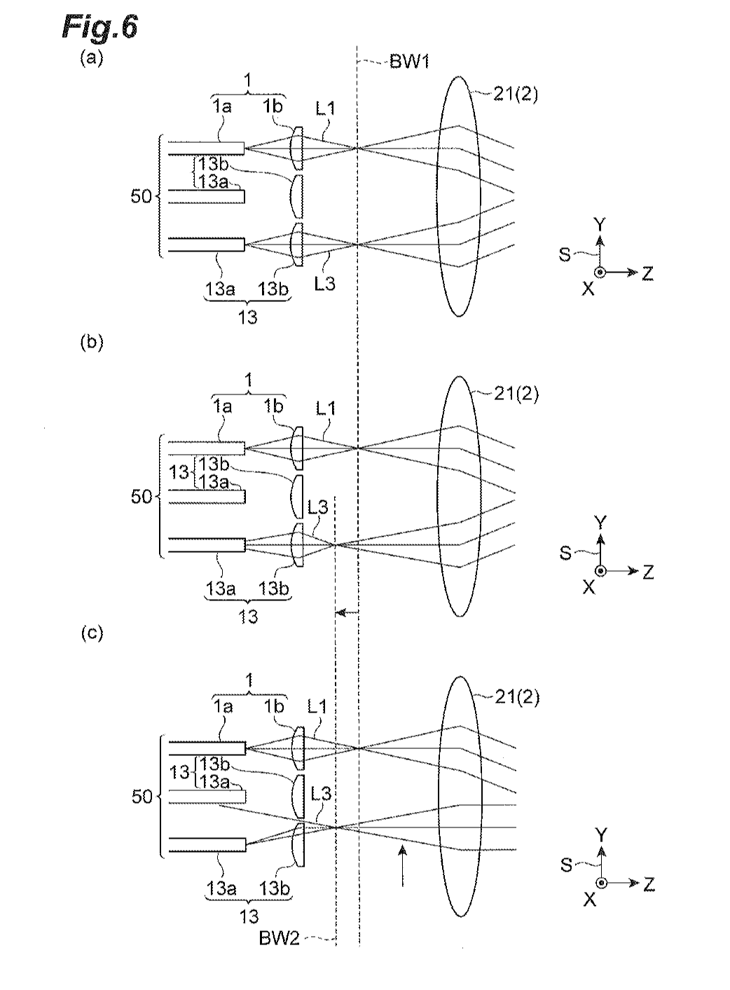

The attenuation control will be described with reference to FIGS. 5 and 6. The input port 1 including an optical fiber 1a and a microlens 1b optically coupled each other, and arranged so as to have an optical axis along the z-axis direction. The output port 13 including an optical fiber 13a and a microlens 13b optically coupled each other, and arranged so as to have an optical axis along the z-axis direction.

FIG. 5 describes a comparative example of the attenuation control. As shown in FIG. 5(a), the phase modulation pattern P as shown in FIG. 2 is presented on the light deflection element 7 under the control of the control unit such that the optical coupling efficiency of the multiplexed light L3 to the output port 13 is maximized. Thus, the beam waist of the wavelength multiplexed light L1 and the multiplexed light L3 substantially coincide with each other at a position BW1 which is located between the microlens 1b (and the microlens 13b) and the cylindrical lens 21 (that is, the anamorphic converter 2) such that the multiplexed light L3 is condensed onto an end face of the optical fiber 13a of the output port 13.

Then, for the purpose of attenuating the optical coupling efficiency of the multiplexed light L3 to the output port 13, the control unit controls only the first pattern P1 to change the optical path of the multiplexed light L3 to the y-axis direction shown by arrow direction in FIG. 5(b). But a portion of the multiplexed light L3 couples to the microlens 13b and the optical fiber 13a of the neighboring output port as to occur cross-talk.

By contrast, the control unit 10 of the present embodiment performs the attenuation control as shown in FIG. 6. The phase modulation pattern P is first presented in the same manner as described above such that the optical coupling efficiency of the multiplexed light L3 to the output port 13 is maximized. Subsequently only the second pattern P2 is changed to shift the beam waist of the multiplexed light L3 between the microlens 13b and the cylindrical lens 21 to the z-axis direction as shown in FIG. 6(b) by arrow direction.

The second pattern P2 is changed such that the beam waist of the multiplexed light L3 is shifted to a position BW2 on the side of the microlens 13b from the position BW1 where the optical coupling efficiency of the multiplexed light L3 to the output port 13 is maximized. This change of the second pattern P2 corresponds to the control to change from the second pattern P2 shown in FIG. 2(b) to the second pattern P2 shown in FIG. 3(b). Accordingly, the beam spot of the multiplexed light L3 incident on the microlens 13b is made relatively smaller.

Subsequently only the first pattern P1 is changed to shift the optical path of the multiplexed light L3 to the y-axis direction as shown in FIG. 6(c) by arrow direction. Since the beam spot of the multiplexed light L3 incident on the microlens 13b has been made smaller by changing the second pattern P2, the multiplexed light L3 may avoid coupling to the neighboring microlens 13b and arising cross-talk.

The control unit 10 controls coupling efficiency of the multiplexed light L3 to the output port 13 to perform a first attenuation step of changing the beam waist of the multiplexed light L3 by changing the second pattern P2. Then performing a second attenuation step of changing the optical path of the multiplexed light L3 by changing the first pattern P1. That is, the control unit 10 changes the optical coupling efficiency by both of positional shifts of the condensing point and optical axis shifts of the multiplexed light L3. By shifting the beam waist position of the multiplexed light L3, the optical coupling efficiency is attenuated, because the beam spot of the multiplexed light L3 on the end face of the optical fiber 13a is expanded. The loss by the first attenuation step is set to be A1, and the loss by the second attenuation step is set to be A2, the first phase pattern P1 and the second phase pattern P2 may be set such that the desired amount of optical attenuation becomes (A1+A2).

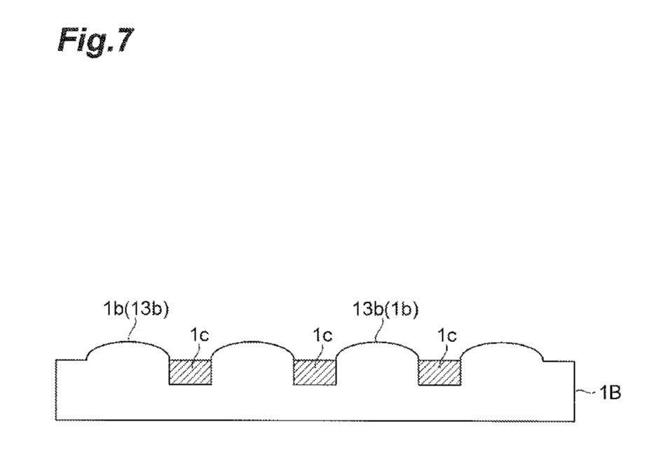

The microlens 1b and the microlens 13b may be a lens array 1B integrated being arranged to have predetermined intervals as shown in FIG. 7. In such a case, an optical absorption portion 1c may be provided between the neighboring microlenses 1b (13b). The optical absorption portion 1c may be provided by doping an optical absorption material (such as P, B, Er or the like) to material forming a lens (such as glass)). The optical absorption portion 1c absorbs the multiplexed light L3 lost from the output port 13 so as to preventing from becoming stray light.

The above embodiment describes an embodiment of the optical device according to an aspect of the present invention. Therefore, the optical device according to an aspect of the present invention is not limited to the above optical path control device 100 and may be any optical device obtained by modifying the optical path control device 100 without deviating from the spirit of each claim.

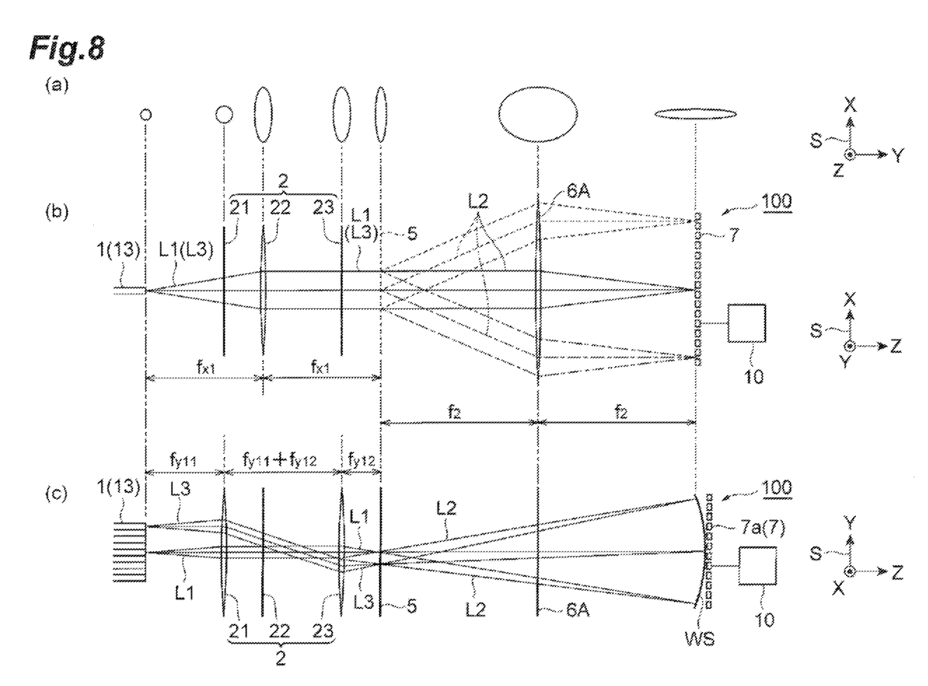

As shown in FIG. 8, an optical power element 6A may be included instead of the optical power element 6 in the optical path control device 100. The optical power element 6A is arranged subsequent to the dispersive element 5 and has optical power only in the x-axis direction (the x-z plane). The optical power element 6A may be a cylindrical lens or the like.

Thus, the optical power element 6A maintains the expansion in the y-axis direction of the wavelength components L2 between the optical power element 6A and the light deflection element 7 such that the aspect ratio of beam spots of the wavelength components L2 incident on the light deflection element 7 may be further enhanced.

The phase modulation pattern P may include any second pattern P2 to control optical characteristics in various optical systems in the optical path control device 100.

The anamorphic converter 2 may be arranged subsequent to the dispersive element 5. The anamorphic converter 2 may include four or more cylindrical lenses.

### INDUSTRIAL APPLICABILITY

An optical device capable of efficiently deflecting light with precision and also capable of suitably controlling optical characteristics can be provided.

### REFERENCE SIGNS LIST

1: Input port, 2: Anamorphic converter, 5: Dispersive element, 6, 6A: Optical power element, 7: Light deflection element, 7a: Light deflection component element, 10: Control unit, 13: Output port, 13a: Optical fiber, 13b: Microlens, 21 to 23: Cylindrical lens, 50: Input/output port array, P: Phase modulation pattern, P1: First pattern, P2: Second pattern

1. An optical device comprising:
an input/output port including an input port and an output port arranged in a first direction;
a dispersive element dispersing an optical signal input from the input port in accordance with the wavelength in a second direction perpendicular to the first direction so as to generate a plurality of wavelength components;
a light deflection element including pixels arranged in the first direction configured to present a phase modulation pattern for independently phase-modulating each of the wavelength components, and the phase modulation pattern including a first pattern for deflecting each of the wavelength components toward the output port, and a second pattern different from the first pattern; and
an anamorphic converter configuring a beam spot of the wavelength components incident on the light deflection element to an elliptical shape relatively larger in the first direction than in the second direction.

2. The optical device according to claim 1, wherein
the light deflection element is arranged at a beam waist of the wavelength components in the second direction and
the second pattern controlling aberration of each of the wavelength components.

3. The optical device according to claim 1, wherein
the output port including an optical fiber and a microlens optically coupled each other and
the second pattern shifting a beam waist of the wavelength component such that the beam waist is positioned at a side of the microlens from a position where optical coupling efficiency of the wavelength component to the optical fiber is maximized.

4. The optical device according to claim 3, wherein the first pattern changing the optical path of the wavelength component in the first direction for controlling the optical coupling efficiency.

5. The optical device according to claim 1, wherein the phase modulation pattern adjusting a wave front of the wavelength component emitting from the light deflection element so as to be substantially identical to a wave front of the wavelength component entering the light deflection element.

6. The optical device according to claim 1, wherein the light deflection element is a liquid crystal device including the pixels two-dimensionally arranged along the first direction and the second direction or an MEMS device including the pixels two-dimensionally arranged along the first direction and the second direction, and wherein the phase modulation pattern configured to be controlled in accordance with a voltage applied to each of the pixels.

7. The optical device according to claim 1, further comprising:
a first optical power element arranged subsequent to the dispersive element and having optical power only in the second direction, and wherein
the anamorphic converter is arranged prior to the dispersive element.

8. The optical device according to claim 1, further comprising:
a second optical power element arranged subsequent to the dispersive element and having optical power in the first direction and the second direction, and wherein
the anamorphic converter includes at least three cylindrical lenses arranged prior to the dispersive element,
two of the cylindrical lenses having optical power in the first direction, and
the other cylindrical lens having optical power in the second direction.
